(19) United States
(12) Patent Application Publication
(10) Pub. No.: US 2021/0279219 A1
(43) Pub. Date: Sep. 9, 2021

(54) SYSTEM AND METHOD FOR GENERATING SYNTHETIC DATASETS

(71) Applicant: Truata Limited, Dublin (IE)

(72) Inventors: Michael Fenton, Greystones (County Wicklow) (IE); Imran Khan, Dublin (IE); Maurice Coyle, Dublin (IE)

(73) Assignee: Truata Limited, Dublin (IE)

(21) Appl. No.: 16/813,331

(22) Filed: Mar. 9, 2020

(51) Int. Cl. G06F 16/22; G06F 16/16; G06F 21/62

(52) U.S. Cl. CPC G06F 16/2264; G06F 21/6263; G06F 16/162; G06F 16/221

(57) ABSTRACT

A system and method for generating one or more synthetic datasets with privacy and utility controls are disclosed. The system and method include an input/output (IO) interface for receiving at least one dataset and a set of privacy controls, at least one privacy controller that provides a set of fine-grained privacy and utility controls based on the received privacy controls for the at least one dataset, a data modeling engine to learn the analytical relationships of the received at least one dataset and to generate a risk and utility profile of the received at least one dataset, a data generation engine to apply learned models in accordance with the provided set of fine-grained privacy and utility controls from the privacy controller to produce one or more synthetic datasets, and a risk mitigation engine that iteratively targets configured risks within the one or more synthetic datasets and mitigates the targeted risks via modification of the one or more synthetic datasets, and outputs a risk profile for the one or more synthetic datasets.

### FIELD OF INVENTION

The present invention is directed to a system and method for generating synthetic datasets, and more particularly a system and method for generating synthetic datasets with privacy and utility controls.

### BACKGROUND

Today the world operates on data. This is true in science, business and even sports. Medical, behavioral, and socio-demographic data are all prevalent in today's data-driven research. However, the collection and use of such data raises legitimate privacy concerns. Therefore, companies frequently want to produce synthesized datasets to support the company's internal or external uses cases. Examples of these use cases include load testing, data analytics, product development, and vendor selection. Each of these uses may have specific requirements regarding the level of utility included in the resulting dataset. At the same time, the context of the dataset usage affects the privacy characteristics and requirements surrounding the data.

### SUMMARY

A system and method for generating one or more synthetic datasets with privacy and utility controls are disclosed. The system and method include an input/output (IO) interface for receiving at least one dataset and a set of privacy controls, at least one privacy controller that provides a set of fine-grained privacy and utility controls based on the received privacy controls for the at least one dataset, a data modeling engine to learn the analytical relationships of the received at least one dataset and to generate a risk and utility profile of the received at least one dataset, a data generation engine to apply learned models in accordance with the provided set of fine-grained privacy and utility controls from the privacy controller to produce one or more synthetic datasets, and a risk mitigation engine that iteratively targets configured risks within the one or more synthetic datasets and mitigates the targeted risks via modification of the one or more synthetic datasets, and outputs a risk profile for the one or more synthetic datasets.

### BRIEF DESCRIPTION OF THE DRAWINGS

A more detailed understanding can be had from the following description, given by way of example in conjunction with the accompanying drawings wherein:

FIG. 1 illustrates a system for generating synthetic datasets with privacy and utility controls;

FIG. 2 illustrates a method of generating synthetic datasets with privacy and utility controls;

FIG. 3 illustrates a method performed in the data modeling engine of FIG. 1 within the method of FIG. 2;

FIG. 4 illustrates a method performed in the data generation engine of FIG. 1 within the method of FIG. 2; and

FIG. 5 illustrates a method performed in the risk mitigation engine of FIG. 1 within the method of FIG. 2.

### DETAILED DESCRIPTION

Synthetic data is becoming a hot topic in the analytics world. However, little work is being done on the privacy and re-identification aspects of synthetic data. A data generation technique that produces a dataset with measurable, configurable privacy and utility characteristics is disclosed. Described is a system and method for generating datasets that bear a configurable resemblance to an original dataset to serve varying purposes within an organization. These purposes will have different requirements around privacy and utility, depending on their nature. The present system and method allows for fine-grained controls over the privacy characteristics of the output data so that it has a well-known risk profile and more effective decisions can be made.

Data synthesis has been defined as a process by which new data is generated, be it based on original real data, a real data schema, or via the use of random generation. Synthetic data can be configured to have greater or lesser analytical utility when compared with the original dataset. Synthetic data can also be configured to have greater or lesser privacy, re-identification, or disclosure risk when compared with the original dataset. In general, a tradeoff exists between analytical utility and privacy risk for any data synthesis technique. Synthetic data may be used in cases when real data is either not available or is less than desirable or feasible to use. Different types of synthetic data can be used for different purposes, e.g., software development, data analytics, or sharing with third parties. For each of these different use cases, differing levels on analytical utility and privacy risk may be required.

A system and method for generating one or more synthetic datasets with privacy and utility controls are disclosed. The system and method include an input/output (IO) interface for receiving at least one dataset and a set of privacy controls, at least one privacy controller that provides a set of fine-grained privacy and utility controls based on the received privacy controls for the at least one dataset, a data modeling engine to learn the analytical relationships of the received at least one dataset and to generate a risk and utility profile of the received at least one dataset, a data generation engine to apply learned models in accordance with the provided set of fine-grained privacy and utility controls from the privacy controller to produce one or more synthetic datasets, and a risk mitigation engine that iteratively targets configured risks within the one or more synthetic datasets and mitigates the targeted risks via modification of the one or more synthetic datasets, and outputs a risk profile for the one or more synthetic datasets.

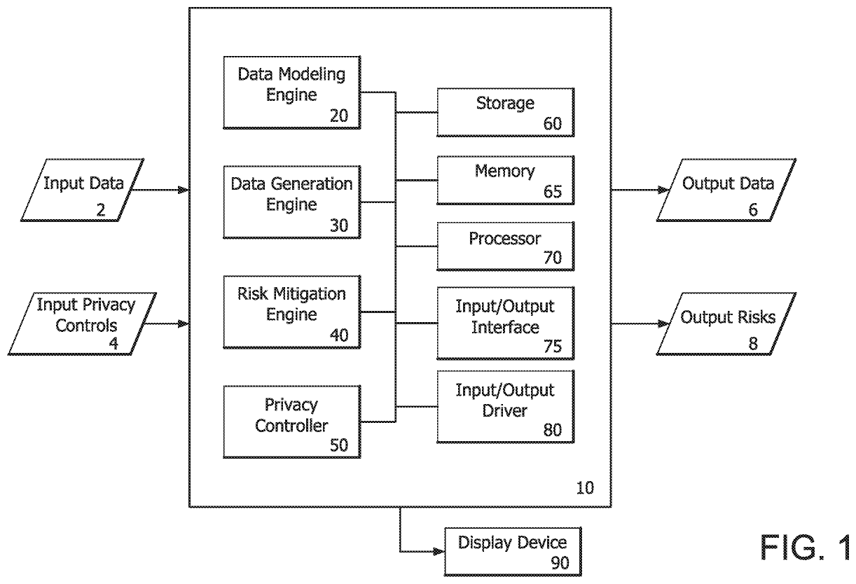

FIG. 1 illustrates a system 10 for generating one or more synthetic datasets with privacy and utility controls. The synthetic dataset is a privacy-controlled dataset based on the input dataset(s). The synthetic datasets may also be referred to as a generated dataset, or the output datasets.

System 10 receives inputs including data inputs 2 and privacy control inputs 4. System 10 produces outputs including data output 6 and risk output 8. Data inputs 2 may include one or more data sets for which a generated data set(s) is desired. In the generated data set the privacy control inputs 4 may be accounted for as will be described below. Data output 6 may include the synthesized, generated or output data set. Risk output 8 may include details related to risks in the data output 6.

System 10 operates using a processor 70 with input/output interfaces 75 and input/output driver 80. System includes storage 60 and memory 65. System 10 includes a data modeling engine 20, a data generation engine 30, a risk mitigation engine 40 and privacy controller 50.

As would be understood by those possessing an ordinary skill in the pertinent arts, data modeling engine 20, data generation engine 30, risk mitigation engine 40 and privacy controller 50 may be interconnected via a bus, and may be placed in storage 60 and/or memory 65 and acted on by processor 70. Information and data may be passed to data modeling engine 20, data generation engine 30, risk mitigation engine 40 and privacy controller 50 internally to system 10 via a bus and this information and data may be received and sent via input/output interface 75.

Data inputs 2 include data sets that as desired to be synthesized or otherwise configured with privacy according to the defined privacy control inputs 4. Generally, data inputs 2 may include data such as 1 million or more credit card transactions, for example. Generally, data inputs 2 are formatted in a row and columnar configuration. The various columns may include specific information on the transaction included within the row. For example, using the credit card transaction example, one row may refer to a particular transaction. The columns in that row may include name, location, credit card number, CVV, signature, and swipe information for example. This provides a row representation of transactions and the columns referring to specific information about the transaction arranged in a columnar fashion. An exemplary sample data inputs 2 dataset is provided below in Table 1. The exemplary data set includes name, education, relationship, marital status, nationality, gender, income and age represented in the columns of the data set and particular entries within the data set for individuals represented in each of the columns of the data set.

TABLE 1
Exemplary Input Data Set

| Name | Education | Relationship | Marital Status | Nationality | Gender | Income | Age |
|---|---|---|---|---|---|---|---|
| Adam | Bachelors | Single | Single | UK | M | 42000 | 25 |
| Bigley | | | | | | | |
| Christine | Masters | Wife | Married | USA | F | 75000 | 32 |
| Dagnet | | | | | | | |
| Edgar | Masters | Single | Divorced | Ireland | M | 80000 | 37 |
| Fitzgerald | | | | | | | |
| Geraldine | HS-grad | Wife | Married | Ireland | F | 32000 | 38 |
| Harris | | | | | | | |
| Ian | Doctorate | Husband | Married | UK | M | 165000 | 53 |
| Jenkins | | | | | | | |
| Kris | HS-grad | Single | Single | USA | M | 19000 | 19 |
| Lemar | | | | | | | |
| Mike | HS-grad | Single | Single | USA | M | 18000 | 18 |
| Nathan | | | | | | | |
| Ophelie | Doctorate | Single | Single | France | F | 125000 | 49 |
| Quirion | | | | | | | |
| Ralph | Masters | Single | Divorced | Germany | M | 64000 | 43 |
| Sacher | | | | | | | |
| Tina | Bachelors | Wife | Married | Germany | F | 41000 | 31 |
| Ullmann | | | | | | | |
| Victor | HS-grad | Husband | Married | Russia | M | 25000 | 27 |
| Wackorev | | | | | | | |
| Xander Yves | Bachelors | Single | Single | Germany | M | 78000 | 50 |
| Zahne | | | | | | | |

Privacy control inputs 4 include inputs that prescribe or dictate the requirements of the generation of the synthetic data set. Privacy control inputs 4 may take the form of a computer file, for example. In a specific embodiment, privacy control inputs 4 may be a configuration file that is in a defined format. For example, an .INI file may be used. Privacy control inputs 4 may include, for example, privacy requirements including limits on the amount of reproduction that is permitted to exist between the input dataset and the synthetic dataset, the levels of granularity to measure the reproduction, the allowable noise and perturbation applied to the synthetic dataset and the level of duplication to enforce in the synthetic dataset. The privacy control inputs 4 may include, for example, analytical utility requirements including which correlations are required, the amount of noise and perturbation applied to the synthetic dataset, and the levels the noise is to be applied.

The content of the privacy control input may include details on the data modelling requirements and desired risk mitigation. The data modelling requirements may include the amount and type of correlations that are permitted (or not permitted) in the output data set. The data modelling requirements may also prescribe a numerical perturbation percentage, a categorical probability noise, a categorical probability linear smoothing, and whether columns are to be sorted automatically or not.

The risk mitigation requirements may also be included within the content of the privacy control input. For example, the risk mitigation requirements may include an indication of whether risks are to be mitigated, whether known anonymization techniques such as k anonymity are to be enforced, instructions on handling crossover or overlap between the original and generated datasets, details of combining columns, and information regarding the quasi-identifier search. K anonymity represents a property possessed by the synthetic data in the data set.

An exemplary privacy control inputs 4 is provided below in Table 2.

TABLE 2
Exemplary Privacy Control Inputs

[DATA MODELLING]
correlations = [Age, Income, Education],
[Relationship, Marital Status]
numerical_perturbation_percent = 5
categorical_probability_noise = 0.2
categorical_probability_linear_smoothing = 0.35
autosort_columns = False
[RISK MITIGATION]
mitigate_risks = True
enforce_k_anonymity = True
k_anonymity_level = 2
delete_exact_matches = one-one, one-many
known_column_combination_risks = [[Age, Gender],
[Age, Gender, Education], [Income, Gender]]
quasi_id_search = True
quasi_id_search_steps = 10000

In the exemplary privacy control inputs of Table 2, correlations are requested to be retained between [Age, Income, Education] and [Relationship, Marital Status] in the synthetic dataset. The data modeling engine 20 model these correlations (correlations=[Age, Income, Education], [Relationship, Marital Status]) specifically, but may not model other correlations. The data modelling engine may also prevent correlations between columns and identifier columns (e.g., name, card number, phone number, email address, etc.) as that may constitute an unacceptably high risk of re-identification.

In the exemplary inputs of Table 2, numerical_perturbation_percent=5 directs the engines to perturb numerical values by up to plus or minus 5%. For example, a value of 100 may become anything between 95 and 105.

In the exemplary inputs of Table 2, the categorical_probability_noise=0.2 adds noise to the probability distributions for sampling of individual categories. As would be understood, a higher noise value means less utility, while achieving more privacy. For example, given an original categorical column where “cat” appears in 20% of the rows, “dog” in 30%, and “fish” in 50%, adding noise to these probabilities may mean that the probability of “cat” appearing changes from 20% to, e.g., 37%, “dog” probability changes from 30% to, e.g., 24%, and “fish” probability changes from 50% to, e.g., 39%.

In the exemplary inputs of Table 2, the categorical_probability_linear_smoothing=0.35 allows the probabilities to be smoothed across different categories such that the probabilities tend towards uniform (i.e., all probabilities are the same). The smoothing value may vary from 0 to 1. A value of 0 means probabilities are unchanged, and a value of 1 means every category has the same probability.

In the exemplary inputs of Table 2, the autosort_columns=False indication sets forth that if the data in the original column was sorted, the data in the synthetic column is to also be sorted, and vice versa.

In the exemplary inputs of Table 2, the indicator mitigate_risks=True provides the ability to turn on/off risk mitigation.

In the exemplary inputs of Table 2, the indicator enforce_k_anonymity=True ensures rows/subsets of rows appear at least k times. This provides a particular anonymization guarantee against specific privacy attacks.

In the exemplary inputs of Table 2, the indicator delete_exact_matches=one-one, one-many allows for specification of which specific types of crossover or overlap risk are to be mitigated.

In the exemplary inputs of Table 2, the indicator known_column_combination_risks=[[Age, Gender], [Age, Gender, Education], [Income, Gender]] provides the ability to specify column combinations that are already known to be risky, and indicates to the engines that these columns are to be examined closely for risks.

In the exemplary inputs of Table 2, the indicator quasi_id_search=True provides a toggle to turn on the optimization/search algorithm to find hidden risks within the dataset (see step 510 of method 500 below).

In the exemplary inputs of Table 2, the indicator quasi_id_search steps=10000 specifies the number of search steps performed in order to find hidden risks. Higher values may require more time to run, but generally result in a more thorough search and a potentially less risky dataset.

Data modeling engine 20 receives as input the data from data inputs 2 and the specified privacy controls from privacy controller 50. Data modeling engine 20 operates to extract the relevant distributions from all columns in the data set, calculates statistical relationships and correlations on the data set, combines the statistical measures, correlations, and distribution information with the specified privacy controls from privacy controller 50 and automatically decides which correlations (if any) are permitted to be modelled. The data modelling engine 20 then outputs a data model that is used as input to the data generation engine 30.

The data modeling engine 20 calculates a data model based on the data inputs 2 and the privacy control inputs 4. Generally, a data model is an abstract model that organizes elements of data and standardizes how they relate to one another and to the properties of real-world entities represented by the rows and columns of the data set. Using the example data set described in Table 1, the data model may for example specify that the data element representing “Name” be composed of a number of other elements which, in turn, represent the Education, Gender, Relationship, Income, etc., to define the characteristics of the Name. The data model may be based on the data in the columns and rows of the data set, the relationship between the data in the columns and rows, semantics of the data in the data set and constraints on the data in the data set. The data model determines the structure of data.

Specifically, a data model is created for each of the columns in the data set individually and across all combinations of columns. Correlations in the data are determined allowing for subsequent comparison of the requested or acceptable correlations. The data model is an abstract description of the data set.

An exemplary sample data model is provided below in Table 3, based on the exemplary data given in Table 1. The exemplary model includes indicative correlation scores between the various columns including name, education, relationship, marital status, nationality, gender, income, and age represented in the columns of the data set.

TABLE 3
Exemplary Data Model

| “Correlations”: { | “Education”: |
|---|---|
| “Name”: | 0.13200479575789492, |
| 0.3861774018729913, | “Relationship”: 1.0, |
| “Marital Status”: | “Relationship”: |
| 0.6605756935653305, | 0.18680369511662176, |
| “Nationality”: | “Marital Status”: |
| 0.2407135617509346, | 0.3533932006492364, |
| “Gender”: 0.6241489492017619, | “Nationality”: |
| “Income”: 0.3861774018729913, | 0.4744190695438112, |
| “Age”: 0.3861774018729913 | “Gender”: 0.024017542121281155, |
| }, | “Income”: 0.546490490941855, |
| “Cardinality”: 3, | “Age”: 0.546490490941855}, |
| “Min Category Size”: 2, | “Cardinality”: 4, |
| “Max Category Size”: 7, | “Min Category Size”: 2, |
| “Mean Category Size”: 4, | “Max Category Size”: 4, |
| “25th Percentile Cat Size”: 2.5, | “Mean Category Size”: 3, |
| “75th Percentile Cat Size”: 5, | “25th Percentile Cat Size”: 2.75, |
| “Median Category Size”: 3, | “75th Percentile Cat Size”: 3.25, |
| “Null Count”: 0, | “Median Category Size”: 3, |
| “Null Percent”: 0 | “Null Count”: 0, |
| }, | “Null Percent”: 0 |
| “Education”: { | }, |
| “Probabilities”: { | “Marital Status”: { |
| “HS-grad”: 0.3333333333333333, | “Probabilities”: { |
| “Bachelors”: 0.25, | “Married”: 0.4166666666666667, |
| “Masters”: 0.25, | “Single”: 0.4166666666666667, |
| “Doctorate”: 0.16666666666666666 | “Divorced”: 0.16666666666666666 |
| }, | }, |
| “Correlations”: { | “Correlations”: { |
| “Name”: 0.546490490941855, | “Name”: 0.41377162374314747, |
| “Education”: | “Education”: |
| 1.0, | 0.26756930061200335, |
| “Relationship”: | “Name”: 0.6859619637674199, |
| 0.7077769854116851, | “Education”: 0.5954969793383103, |
| “Marital Status”: 1.0, | “Relationship”: |
| “Nationality”: | 0.4275764110568725, |
| 0.21316645262564526, | “Marital Status”: |
| “Gender”: 0.2318748551381048, | 0.35339320064923596, |
| “Income”: 0.41377162374314747, | “Nationality”: 1.0, |
| “Age”: 0.41377162374314747 | “Gender”: 0.3185043855303207, |
| }, | “Income”: 0.6859619637674199, |
| “Cardinality”: 3, | “Age”: 0.6859619637674199 |
| “Min Category Size”: 2, | }, |
| “Max Category Size”: 5, | “Cardinality”: 6, |
| “Mean Category Size”: 4, | “Min Category Size”: 1, |
| “25th Percentile Cat Size”: 3.5, | “Max Category Size”: 3, |
| “75th Percentile Cat Size”: 5, | “Mean Category Size”: 2, |
| “Median Category Size”: 5, | “25th Percentile Cat Size”: 1.25, |
| “Null Count”: 0, | “75th Percentile Cat Size”: 2.75, |
| “Null Percent”: 0 | “Median Category Size”: 2, |
| }, | “Null Count”: 0 |
| “Nationality”: { | “Null Percent”: 0}, |
| “Probabilities”: { | “Gender”: { |
| “USA”: 0.25, | “Probabilities”: { |
| “Germany”: 0.25, | “M”: 0.6666666666666666, |
| “Ireland”: 0.16666666666666666, | “F”: 0.3333333333333333 |
| “UK”: 0.16666666666666666, | }, |
| “Russia”: 0.08333333333333333, | “Correlations”: { |
| “France”: 0.08333333333333333 | “Name”: 0.25615214493032046, |
| }, | “Education”: |
| “Correlations”: { | 0.011257551654224596, |
| “Relationship”: | “Age”: 1.0 |
| 0.4139990877731846, | }, |
| “Marital Status”: | “Cardinality”: 12, |
| 0.14354595165738815, | “Min Category Size”: 1, |
| “Nationality”: | “Max Category Size”: 1, |
| 0.11893601370435081, | “Mean Category Size”: 1, |
| “Gender”: 1.0, | “25th Percentile Cat Size”: 1, |
| “Income”: 0.25615214493032046, | “75th Percentile Cat Size”: 1, |
| “Age”: 0.25615214493032046 | “Median Category Size”: 1, |
| }, | “Null Count”: 0, |
| “Cardinality”: 2, | “Null Percent”: 0 |
| “Min Category Size”: 4, | }, |
| “Max Category Size”: 8, | “Income”: { |
| “Mean Category Size”: 6, | “Correlations”: { |
| “25th Percentile Cat Size”: 5, | “Name”: 1.0, |
| “75th Percentile Cat Size”: 7, | “Education”: 0.6666666666666666, |
| “Median Category Size”: 6, | “Relationship”: |
| “Null Count”: 0, | 0.5333333333333333, |
| “Null Percent”: 0 | “Marital Status”: |
| }, | 0.4444444444444444, |
| “Name”: { | “Nationality”: |
| “Correlations”: { | 0.3333333333333333, |
| “Name”: 1.0, | “Gender”: 0.5, |
| “Education”: 1.0, | “Income”: 1.0, |
| “Relationship”: 1.0, | “Age”: 0.8321678321678322 |
| “Marital Status”: 1.0, | }, |
| “Nationality”: 1.0, | “Count”: 12.0, |
| “Gender”: 1.0, | “Mean”: 63666.666666666664, |
| “Income”: 1.0, | “Std”: 44916.75802543135, |
| “Min”: 18000.0, | “Gender”: 0.5, |
| “25th Percentile”: 30250.0, | “Income”: 0.8321678321678322, |
| “Median”: 53000.0, | “Age”: 1.0 |
| “75th Percentile”: 78500.0, | }, |
| “Max”: 165000.0, | “Count”: 12.0, |
| “Null Count”: 0, | “Mean”: 35.166666666666664, |
| “Null Percent”: 0 | “Std”: 11.892192498620362, |
| }, | “Min”: 18.0, |
| “Age”: { | “25th Percentile”: 26.5, |
| “Correlations”: { | “Median”: 34.5, |
| “Name”: 1.0, | “75th Percentile”: 44.5, |
| “Education”: 0.3333333333333333, | “Max”: 53.0 , |
| “Relationship”: | “Null Count”: 0, |
| 0.5333333333333333, | “Null Percent”: 0 |
| “Marital Status”: 0.0, | } |
| “Nationality”: | } |
| 0.3333333333333333, | |

In Table 3, the exemplary data model illustrates that 25% of the records are from the USA (USA; 0.25) and 25% are from Germany (Germany; 0.25). Further, marital status is indicated to be strongly correlated with relationship, i.e., people who are married are more likely to be in a relationship (“Marital Status”: “Relationship”: 0.7077769854116851.) Further, the model indicates that 2/3 of the records pertain to males (“M”: 0.6666666666666666, “F”: 0.3333333333333333). From the correlations values for the column “Name” (“Name”: 1.0, “Education”: 1.0, “Relationship”: 1.0, “Marital Status”: 1.0, “Nationality”: 1.0, “Gender”: 1.0, “Income”: 1.0, “Age”: 1.0), this indicates that there is a unique name for each row. Every name has a perfect relationship to every other variable, as if you know the name, you know everything else about that person in the dataset. Further, education is highly correlated with income, i.e. the more educated someone is, the more one would expect them to earn (“Income”: “Education”: 0.6666666666666666) Further, in the model income is highly correlated with age (“Age”: “Income”: 0.8321678321678322). The older a person is in the dataset, the more likely they are to have a higher income. The reverse is also true in the dataset, that the higher a person's income, the more likely it is that they are going to be older. The data model indicates that there are no Null values in certain columns of the dataset (“Null Count”: 0, “Null Percent”: 0). Therefore, the present system would not include any null values in the synthetic dataset. Further, the distribution/spread of age within the dataset is “Min”: 18.0, “25th Percentile”: 26.5, “Median”: 34.5, “75th Percentile”: 44.5, and “Max”: 53.0. These metrics on age, for example, may allow the present system to reproduce a new synthetic “age” column that has similar properties.

It should be understood that the exemplary data model and subsequent description are provided as illustrative examples rather than definitive descriptions. As would be understood by those possessing an ordinary skill in the pertinent arts, additional abstract aspects of the data model such as modelled correlations can be included in the model itself. Furthermore, the contents of the data model can be affected by the privacy control inputs from privacy controller 50.

Data generation engine 30 receives as input the data model output from the data modeling engine 20 and the specified privacy controls from privacy controller 50. Based on the desired configuration, data generation engine 30 checks the specification for the required output dataset, including number of rows, specific columns, and desired correlations, applies the permitted correlation models (if required) to generate correlated subsets of output data, and applies the given distribution models (if required) to generate independent un-correlated subsets of output data.

The synthetic dataset, also referred to as output dataset, and generated dataset, generated by the data generation engine 30 may look to an observer to be similar to the data inputs 2, as provided in exemplary form in Table 1, with the exception that the synthetic dataset is synthesized based on, and in accordance with, the input privacy controls 4. That is, the synthesized data may include the same number of rows, columns and the like (depending on the configuration settings), and generally includes the same types of data attributes found in the input dataset. An exemplary synthetic dataset is provided in Table 4.

TABLE 4
Exemplary Synthetic Dataset

| Name | Education | Relationship | Marital Status | Nationality | Gender | Income | Age |
|---|---|---|---|---|---|---|---|
| Cynthia | Masters | Single | Divorced | France | F | 61430 | 44 |
| Philippe | | | | | | | |
| Emma | HS-grad | Single | Single | Ireland | F | 20796 | 29 |
| Costigan | | | | | | | |
| Heidi | Bachelors | Husband | Married | Germany | F | 39727 | 43 |
| Klum | | | | | | | |
| Ian | Bachelors | Single | Single | UK | M | 71603 | 49 |
| Smith | | | | | | | |
| Matt | Doctorate | Single | Single | USA | M | 80383 | 56 |
| Clay | | | | | | | |
| Michael | Masters | Wife | Married | UK | M | 171916 | 68 |
| Duncan | | | | | | | |
| Michel | Doctorate | Wife | Married | France | M | 131415 | 58 |
| Boucher | | | | | | | |
| Padraig | HS-grad | Single | Single | Ireland | M | 19117 | 19 |
| Pearse | | | | | | | |
| Peter | HS-grad | Single | Divorced | UK | M | 24147 | 36 |
| Barry | | | | | | | |
| Richard | HS-grad | Husband | Married | UK | M | 35246 | 40 |
| Flood | | | | | | | |
| Sean | Masters | Single | Single | Ireland | M | 79984 | 54 |
| Murphy | | | | | | | |

In the exemplary synthetic dataset of Table 4, the correlations have been preserved between [Age, Income, Education], and [Relationship, Marital Status] as requested in the exemplary privacy control inputs of Table 2. A+−5% perturbation has been added to numerical columns of age and income. In general, the dataset represents that as age increases so does income, while an increase in income is also correlated with an increase in education level. Separately, there is a link between married individuals and their relationship status. No correlation has been preserved between relationship status and sex, for example, as we have female husbands and male wives. The “Names” column is completely new, with no crossover of names from the original dataset.

Risk mitigation engine 40 receives as input the original dataset from data inputs 2, the generated dataset, and the specified privacy controls from privacy controller 50. the specified privacy controls from privacy controller 50 searches through the original dataset to find potential hidden re-identification risks, compares the original and generated datasets to identify any of these hidden risks that may occur in the generated dataset, searches through the generated dataset to find overt (i.e., non-hidden) re-identification risks, including potential risks specified in the privacy controls, applies configured mitigation techniques to the output data based on the privacy controls, including deletion, multiplication, redaction, fuzzing, and returns the mitigated dataset, and the risk profile of that dataset.

While each of data modeling engine 20, data generation engine 30 and risk mitigation engine 40 are described as engines, each of these includes software and the necessary hardware to perform the functions described. For example, in computer programming, an engine is a program that performs a core or essential function for other programs. Engines are used in operating systems, subsystems or application programs to coordinate the overall operation of other programs. Each of these engines uses an algorithm to operate on data to perform a function as described.

Privacy controller 50 provides privacy controls that are provided as a means to set desired specifications and limits for privacy and re-identification risk in the outputted data. These controls include specification for specific column correlations, hard limits on the privacy/risk profile, and specification for output data structure and format (e.g., number of rows, specific columns).

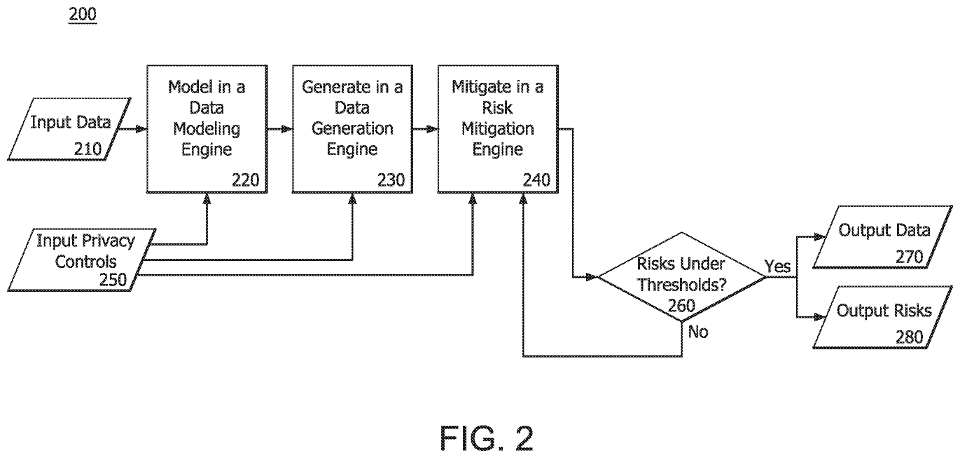

A check unit (not shown in FIG. 1, referenced in step 260 of FIG. 2) may be included within system 10. Check unit may be included within the risk mitigation engine 40 and/or may be include individually within system 10. Check unit may perform a threshold check on the risk profile outputted from the risk mitigation engine 40. Such a check may determine if the risks are under the configured thresholds, deeming the data safe for the given privacy control input, and releasing the data. If the risks are not under the configured limits, then the risk mitigation engine 40 is iteratively executed until the risks are under the limits. This iterative step is necessary as new risks can be introduced to the output dataset through the mitigation of previous risks.

The storage 60 includes a fixed or removable storage, for example, a hard disk drive, a solid state drive, an optical disk, or a flash drive. Input devices (not shown) may include, without limitation, a keyboard, a keypad, a touch screen, a touch pad, a detector, a microphone, an accelerometer, a gyroscope, a biometric scanner, or a network connection (e.g., a wireless local area network card for transmission and/or reception of wireless IEEE 802 signals). Output devices 90 include, without limitation, a display, a speaker, a printer, a haptic feedback device, one or more lights, an antenna, or a network connection (e.g., a wireless local area network card for transmission and/or reception of wireless IEEE 802 signals).

In various alternatives, the processor 70 includes a central processing unit (CPU), a graphics processing unit (GPU), a CPU and GPU located on the same die, or one or more processor cores, wherein each processor core can be a CPU or a GPU. In various alternatives, the memory 65 is located on the same die as the processor 70, or is located separately from the processor 70. The memory 65 includes a volatile or non-volatile memory, for example, random access memory (RAM), dynamic RAM, or a cache.

The input/output driver 80 communicates with the processor 70 and the input devices (not shown), and permits the processor 70 to receive input from the input devices via input/output driver 80. The input/output driver 80 communicates with the processor 70 and the output devices 90 via input/output driver 80, and permits the processor 70 to send output to the output devices 90. It is noted that the input/output driver 80 are optional components, and that the system 10 will operate in the same manner if the input/output driver 80 is not present.

FIG. 2 illustrates a method 200 of generating synthetic datasets with privacy and utility controls in conjunction with the system of FIG. 1. Method 200 begins with an input of data at step 210. The input of data at step 210 may include inputting one or more data sets. The input data from step 210 is provided to a data modeling engine at step 220. The output of the data modeling engine is input to a data generation engine at step 230. The output of the data generation engine is input to the risk mitigation engine at step 240. Privacy controls via a privacy controller are also inputs to data modeling engine, data generation engine and risk mitigation engine at step 250. The output of risk mitigation engine is provided as an input to a checker to determine if the risks are under thresholds at step 260. If the risks are not under the thresholds, the risk mitigation engine is iteratively repeated at step 240. If the risks are determined to be under the threshold in step 260, the data is output at step 270 and the risks are output at step 280.

Privacy controls are input to data modeling engine, data generation engine and risk mitigation engine at step 250 to set desired specifications and limits for privacy and re-identification risk in the outputted data.

The data modelling engine at step 220 receives as input the input data and the specified privacy controls at step 250. The data modelling engine then outputs a data model that is used as input to the data generation engine at step 230.

The data generation engine at step 230 receives as input the data model and the specified privacy controls at step 250. Based on the desired configuration, the generation engine operates on the data and outputs the data to the risk mitigation engine at step 240.

The risk mitigation engine at step 240 takes as input the original dataset, the generated dataset, and the specified privacy controls at step 250 to assess and search for risks and outputs the mitigated dataset, and the risk profile of that dataset.

A threshold check is then performed at step 260 on the risk profile outputted from the risk mitigation engine. If the risks are under the configured thresholds, then the data is deemed safe for the given privacy control input, and the data is output at step 270 and the risks output at step 280. If the risks are not under the configured limits, then the risk mitigation engine is iteratively executed at step 240 until the risks are under the limits in step 260. This iterative step is necessary as new risks can be introduced to the output dataset through the mitigation of previous risks.

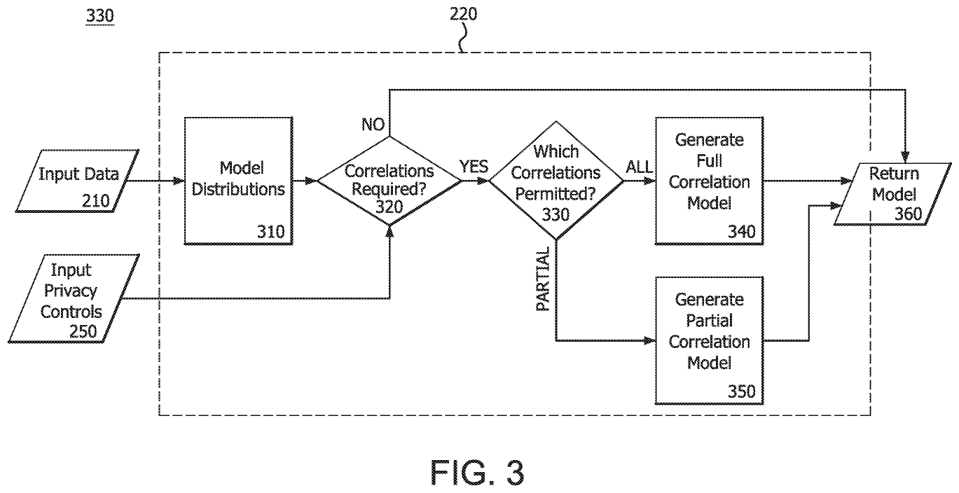

FIG. 3 illustrates a method 300 performed in the data modeling engine of FIG. 1 within the method of FIG. 2. Method 300 provides a more detailed view of the steps performed in step 220 of method 200. Specifically, the inputs to the data modeling engine include the input of data at step 210 and the input of privacy information at step 250. Within the data modeling engine, method 300 is performed. Method 300 includes modeling distributions by calculating distributions and probabilities over the input dataset at step 310. The distribution model at step 310 take as input the data and extracts the relevant distributions from all columns in the dataset. The distribution model at step 310 outputs the extracted distributions, and the input privacy controls at step 250 of method 200 to determine if correlations are required at step 320. If the correlations are not required from step 320, method 300 advances to a return to the model at step 360. If correlations are required at step 320, then a determination of which correlations are permitted occurs at step 330. If all correlations are permitted, method 300 generates a full correlation model at step 340. If a partial set of correlations are permitted, method 300 generates a partial correlation model at step 350. Depending on the generated correlation model in step 340 or step 350, method 300 continues with the statistical measures, correlations, and distribution information being combined with the specified privacy controls to automatically decide which correlations (if any) are permitted to be modelled. Depending on the correlations permitted, the full correlation model or the partial correlation model is returned at step 360.

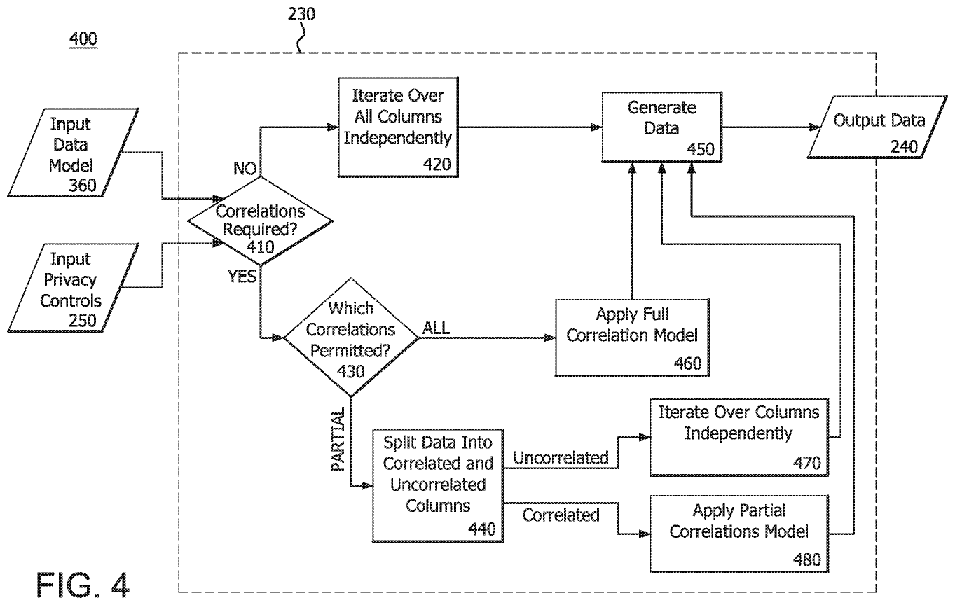

FIG. 4 illustrates a method 400 performed in the data generation engine of FIG. 1 within the method of FIG. 2. Method 400 provides a more detailed view of the steps performed in step 230 of method 200. Specifically, the inputs to the data generation engine include the input of data at step 210 and the input of privacy information at step 250. Within the data generation engine, method 400 is performed. Method 400 includes steps to determine whether to apply a full correlation model, a partial correlation model, or to iterate over all of the columns independently. These determinations are informed by checking the specification for the required output dataset, including number of rows, specific columns, and desired correlations and applying the permitted correlation models (if required) to generate correlated subsets of output data, or the given distribution models (if required) to generate independent un-correlated subsets of output data.

Method 400 includes a determination of correlations are required at step 410. If no correlations are required, at step 420 method 400 iterates over all columns independently. If correlations are required, method 400 determines which correlations are permitted at step 430. If all correlations are permitted, method 400 applies a full correlation model at step 460. If a subset of correlations is permitted at step 430, the data is split into correlated and uncorrelated columns at step 440. The uncorrelated columns are then iterated over columns independently at step 470 and the correlated columns are applied in a partial correlation model at step 480. After the application a full correlation model (step 460), a partial correlation model (step 480), or to iterate over all of the columns independently (either step 420 or step 470), the data is generated at step 450. The generated data is output at step 240 of method 200.

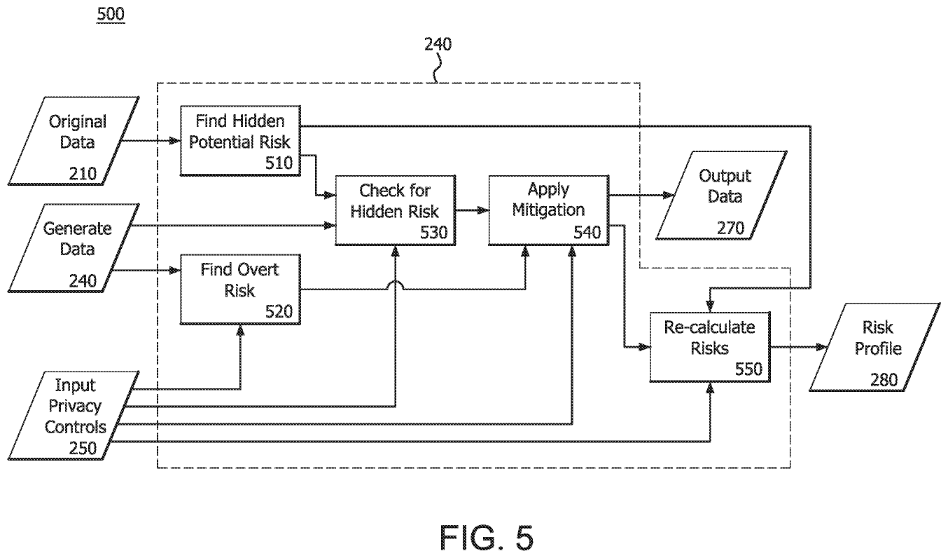

FIG. 5 illustrates a method 500 performed in the risk mitigation engine of FIG. 1 within the method of FIG. 2. Method 500 provides a more detailed view of the steps performed in step 240 of method 200. Specifically, the inputs to the risk mitigation engine include the input of data at step 210, the input of generated data at step 240 and the input of privacy information at step 250. Within the risk mitigation engine, method 500 is performed. Method 500 includes finding hidden potential risks at step 510 by searching through the original dataset to find potential hidden re-identification risks. Method 500 finds overt risks at step 520 by searching through the generated dataset to find overt (i.e., non-hidden) re-identification risks, including potential risks specified in the privacy controls. At step 530, the original and generated datasets are compared to identify any of these hidden risks that may occur in the generated dataset. At step 540, mitigation techniques are applied to the output data (generated datasets) based on the privacy controls, including, but not limited to deletion, multiplication, redaction, and fuzzing, for example. The risk based on the mitigated data is then recalculated at step 550. Method 500 returns the mitigated dataset at step 270 of method 200, and the risk profile of that dataset at step 280 of method 200. If the threshold check at step 260 is passed, the mitigated dataset returned is data output 6, which may include the synthesized, generated or output data set.

It should be understood that many variations are possible based on the disclosure herein. Although features and elements are described above in particular combinations, each feature or element can be used alone without the other features and elements or in various combinations with or without other features and elements.

The various functional units illustrated in the figures and/or described herein may be implemented as a general purpose computer, a processor, or a processor core, or as a program, software, or firmware, stored in a non-transitory computer readable medium or in another medium, executable by a general purpose computer, a processor, or a processor core. The methods provided can be implemented in a general purpose computer, a processor, or a processor core. Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine. Such processors can be manufactured by configuring a manufacturing process using the results of processed hardware description language (HDL) instructions and other intermediary data including netlists (such instructions capable of being stored on a computer readable media). The results of such processing can be maskworks that are then used in a semiconductor manufacturing process to manufacture a processor which implements features of the disclosure.

The methods or flow charts provided herein can be implemented in a computer program, software, or firmware incorporated in a non-transitory computer-readable storage medium for execution by a general purpose computer or a processor. Examples of non-transitory computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

What is claimed is:

1. A system for generating one or more synthetic datasets with privacy and utility controls, the system comprising:
an input/output (IO) interface for receiving at least one dataset and a set of privacy controls to be applied to the at least one dataset;
at least one privacy controller that receives the set of privacy controls and provides a set of fine-grained privacy and utility controls based on the received privacy controls for the at least one dataset;
a data modeling engine to learn the analytical relationships of the received at least one dataset and to generate a risk and utility profile of the received at least one dataset;
a data generation engine to apply learned models in accordance with the provided set of fine-grained privacy and utility controls from the privacy controller to produce one or more synthetic datasets; and
a risk mitigation engine that iteratively targets configured risks within the one or more synthetic datasets and mitigates the targeted risks via modification of the one or more synthetic datasets, and outputs a risk profile for the one or more synthetic datasets,
wherein the IO interface outputs the one or more synthetic datasets with known privacy and utility characteristics.

2. The system of claim 1 wherein the IO interface outputs the risk profile for the one or more synthetic datasets.

3. The system of claim 1 wherein the data modeling engine learns the analytical relationships of the received at least one dataset and generates a risk and utility profile of the received at least one dataset by extracting the relevant distributions from all columns in the dataset and calculating statistical relationships and correlations on the data.

4. The system of claim 1 wherein the data modeling engine outputs the extracted distributions to determine if correlations are permitted in the outputs the one or more synthetic datasets.

5. The system of claim 1 wherein a full correlation model is performed in the data modeling engine.

6. The system of claim 1 wherein a partial correlation model is performed in the data modeling engine.

7. The system of claim 1 wherein the data generation engine applies learned models in accordance with the provided set of fine-grained privacy and utility controls from the privacy controller to produce one or more synthetic datasets by checking the specification for the required output dataset, including number of rows, specific columns, and desired correlations.

8. The system of claim 1 wherein the data generation engine applies the permitted correlation models to generate correlated subsets of output data.

9. The system of claim 1 wherein the data generation engine applies the given distribution models to generate independent un-correlated subsets of output data.

10. The system of claim 1 wherein the risk mitigation engine finds hidden potential risks by searching through the original dataset to find potential hidden re-identification risks.

11. The system of claim 1 wherein the risk mitigation engine finds overt risks by searching through the generated dataset to find overt re-identification risks.

12. The system of claim 11 wherein the re-identification risks include potential risks specified in the privacy controls.

13. The system of claim 1 wherein the risk mitigation engine compares the original and generated datasets to identify hidden risks that may occur in the generated dataset.

14. The system of claim 1 wherein the risk mitigation engine applies mitigation techniques to the generated dataset based on the privacy controls.

15. The system of claim 14 wherein the mitigation techniques include at least one of deletion, multiplication, redaction, and fuzzing.

16. The system of claim 1 wherein the at least one privacy controller is configurable to set exact specification for privacy requirements for the dataset based on the privacy controls.

17. The system of claim 1 wherein the at least one privacy controller is configurable to set exact specification for analytical utility requirements for the dataset via utility controls.

18. A method of generating synthetic datasets with privacy and utility controls, the method comprising:
receiving, via an input/output (IO) interface, at least one dataset and a set of privacy controls to be applied to the at least one dataset;
providing, via at least one privacy controller, a set of fine-grained privacy and utility controls based on the received privacy controls for the at least one dataset;
establishing the analytical relationships of the received at least one dataset and generating a risk and utility profile of the received at least one dataset;
applying learned models in accordance with the provided set of fine-grained privacy and utility controls from the privacy controller to produce one or more synthetic datasets;
iteratively targeting configured risks within the one or more synthetic datasets and mitigating the targeted risks via modification of the one or more synthetic datasets;
outputting the one or more synthetic datasets with known privacy and utility characteristics and a risk profile for the one or more synthetic datasets.

19. The method of claim 18, further comprising performing a threshold check on the output risk profile.

20. The method of claim 19, further comprising re-targeting configured risks if the threshold check are not under configured limits.
